(19) United States
(12) Patent Application Publication
(10) Pub. No.: US 2010/0325374 A1
(43) Pub. Date: Dec. 23, 2010

(54) DYNAMICALLY CONFIGURING MEMORY INTERLEAVING FOR LOCALITY AND PERFORMANCE ISOLATION

(75) Inventors: Robert E. Cypher, Saratoga, CA (US); Shailender Chaudhry, San Francisco, CA (US); Anders Landin, San Carlos, CA (US); Haakan E. Zeffer, Santa Clara, CA (US)

Correspondence Address: PVF -- ORACLE AMERICA, INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/486,138

(22) Filed: Jun. 17, 2009

(51) Int. Cl. G06F 12/10; G06F 12/02; G06F 12/00

(52) U.S. Cl. 711/157; 711/206; 711/170; 711/E12.001; 711/E12.002; 711/E12.059

(57) ABSTRACT

Embodiments of the present invention provide a system that dynamically reconfigures memory. During operation, the system determines that a virtual memory page is to be reconfigured from an original virtual-address-to-physical-address mapping to a new virtual-address-to-physical-address mapping. The system then determines a new real address mapping for a set of virtual addresses in the virtual memory page by selecting a range of real addresses for the virtual addresses that are arranged according to the new virtual-address-to-physical-address mapping. Next, the system temporarily disables accesses to the virtual memory page. Then, the system copies data from real address locations indicated by the original virtual-address-to-physical-address mapping to real address locations indicated by the new virtual-address-to-physical-address mapping. Next, the system updates the real-address-to-physical-address mapping for the page, and re-enables accesses to the virtual memory page.

### BACKGROUND

1. Field of the Invention

The present invention relates to techniques for improving the performance of computer systems. More specifically, the present invention relates to a method and apparatus for dynamically configuring computer memory.

2. Related Art

Modern multiprocessing computer systems often include two or more processors (or processor cores) that are used to perform computing tasks. One common architecture in multiprocessing systems is a shared memory architecture in which multiple processors share a common memory. A common variant of shared memory systems is a distributed shared memory architecture, which includes multiple distributed “nodes” within which separate processors and/or memory reside. Each of the nodes is coupled to a network that is used to communicate with the other nodes. When considered as a whole, the memory included within each of the multiple nodes forms the shared memory for the computer system.

In some distributed shared memory systems, memory is allocated among the nodes in a cache line interleaved manner. In these systems, a given node is not allocated blocks of contiguous cache lines. Rather, in a system which includes N nodes, each node may be allocated every Nth cache line of the address space (and thus each node may be the “home node” for a portion of the cache lines). Interleaving cache lines can make certain patterns of memory accesses more efficient because the nodes can provide the allocated cache lines to a requesting processor independent of one another, facilitating retrieving cache lines from consecutive memory addresses in parallel. Hence, memory interleaving can benefit some applications. However, other applications are better suited for non-interleaved (i.e., contiguous) memory, which can map consecutive memory addresses to the same home node, thereby placing these cache lines closer to a consuming processor.

Some computer systems support the simultaneous use of both interleaved and non-interleaved memory. In these systems, the memory is statically partitioned into predetermined interleaved and non-interleaved regions so that the regions do not change their interleaved or non-interleaved status during operation. For example, some computer systems assign each home node to be either interleaved or non-interleaved. In such systems, a processor can access an interleaved or a non-interleaved region of memory by selecting a range of memory addresses that is associated with a home node with the corresponding memory arrangement. Although sometimes useful, the applicability of this approach is limited due to the static assignment of the size and type of each region of memory. Moreover, moving copies of data between home nodes while maintaining cache coherency can require complex hardware and/or software support.

### SUMMARY

Embodiments of the present invention provide a system (e.g., computer system 100 in FIG. 1) that dynamically reconfigures memory. During operation, the system determines that a virtual memory page is to be reconfigured from an original virtual-address-to-physical-address mapping to a new virtual-address-to-physical-address mapping. The system then determines a new real address mapping for a set of virtual addresses in the virtual memory page by selecting a range of real addresses for the virtual addresses that are arranged according to the new virtual-address-to-physical-address mapping. Next, the system temporarily disables accesses to the virtual memory page. The system then copies data from real address locations indicated by the original virtual-address-to-physical-address mapping to real address locations indicated by the new virtual-address-to-physical-address mapping. Next, the system updates the real-address-to-physical-address mapping for the page, and re-enables accesses to the virtual memory page.

In some embodiments, the possible virtual-address-to-physical-address mappings for the virtual memory page include a contiguous mapping and an interleaved mapping. In a contiguous mapping, the virtual addresses in the virtual memory page map to a corresponding range of real addresses, wherein the range of real addresses is mapped to a set of consecutively located physical addresses. In an interleaved mapping, the virtual addresses map to a corresponding range of real addresses, wherein the range of real addresses is mapped to a set of cyclically located physical addresses.

In some embodiments, reconfiguring the virtual memory page involves converting the virtual page from being contiguously mapped to being interleavedly mapped, or converting the virtual page from being interleavedly mapped to being contiguously mapped.

In some embodiments, the system receives one or more ranges of real addresses that are contiguously mapped or one or more ranges of real addresses that are interleavedly mapped.

In some embodiments, for the contiguous mapping, the consecutively located physical addresses are located in one bank of a multi-bank cache, and for the interleaved mapping, the cyclically located physical addresses are located in two or more corresponding banks of a multi-bank cache. In these embodiments, determining that a virtual memory page is to be reconfigured involves determining that an operating condition has occurred that makes accessing cache lines within the cache more efficient using the other real-address-to-physical-address mapping.

In some embodiments, for the contiguous mapping, the consecutively located physical addresses are located within a section of a cache bank, and for the interleaved mapping, the cyclically located physical addresses are located in two or more corresponding sections (i.e., subsets of indices) of multi-bank caches.

In some embodiments, temporarily disabling access to the virtual memory page involves performing a TLB shootdown, wherein performing the TLB shootdown involves at least one of: generating an interrupt, generating an exception, setting special register bits, or using memory-based semaphores.

### BRIEF DESCRIPTION OF THE FIGURES

FIG. 1 presents a block diagram of a computer system in accordance with embodiments of the present invention.

FIG. 2 is a diagram illustrating in more detail a portion of the computer system in accordance with embodiments of the present invention.

FIG. 3 presents a block diagram of a mapping unit in accordance with embodiments of the present invention.

FIG. 4 presents a flow chart illustrating a method for dynamically reconfiguring memory in accordance with embodiments of the present invention.

Like reference numerals refer to corresponding parts throughout the figures.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described below can be included in hardware modules. For example, the hardware modules can include, but are not limited to, application-specific integrated circuit (ASIC) chips, field programmable gate arrays (FPGAs), and other programmable-logic devices now known or later developed. When the hardware modules are activated, the hardware modules perform the methods and processes included within the hardware modules.

### Terminology

Throughout this description, we use the following terminology in describing embodiments of the present invention. These terms are generally known in the art, but are defined below to clarify the subsequent descriptions.

The term “cache line” as used in this description refers to a set of bytes that can be stored in a cache or to memory. In some embodiments, the cache line includes 64 bytes, although cache lines of different numbers of bytes can be used. In some embodiments of the present invention, a cache line can reside in a large, DRAM-based cache.

The term “home node” as used in this description to refer to a physical memory location, generally refers to any type of computational resource where a memory line resides within a computer system. For example, a home node can be a memory module, or a processor with memory. In some embodiments of the present invention, a home node can be any memory location where a given memory controller keeps a record of the coherency status of the cache line. In some embodiments, each cache line has a single corresponding home node.

In these embodiments, a given node is not allocated a block of contiguous memory addresses. Rather, in a system which includes N nodes, each node may be allocated every Nth memory address of an address space (and thus, each node may be the home node for a portion of the cache lines). For example, for N-way interleaving with N home nodes, a home node H can include addresses N·i+H, where i is an integer and 0≦H<N. Interleaving can be performed in a cache line interleaved manner, i.e., at cache line granularity. In other embodiments of the present invention, interleaving can be performed at the granularity of a byte or multiples of a byte or in blocks of cache lines.

The term “cyclically located” as used in this description to refer to cache lines refers to cache lines that map to different cache banks of a cache in an interleaved manner. In these embodiments, consecutive cache lines map to different cache banks.

The term “interleavedly mapped” is used in this description to refer to a virtual memory page for which a contiguous set of virtual addresses maps to cyclically located physical memory locations. As will be described in detail below, the contiguous set of virtual addresses can map to a contiguous set of real addresses, which in turn can map to cyclically located physical memory locations.

The term “interleavedly” as used in this description refers to mapping consecutive real addresses to a set of cyclically located physical addresses, i.e. physical addresses that are associated with cyclically located physical memory locations.

The term “virtual machine” as used in this description refers to a hardware virtual machine (e.g., a processor, or a processor core), or a software virtual machine (e.g., an instance of an operating system).

### Computer System

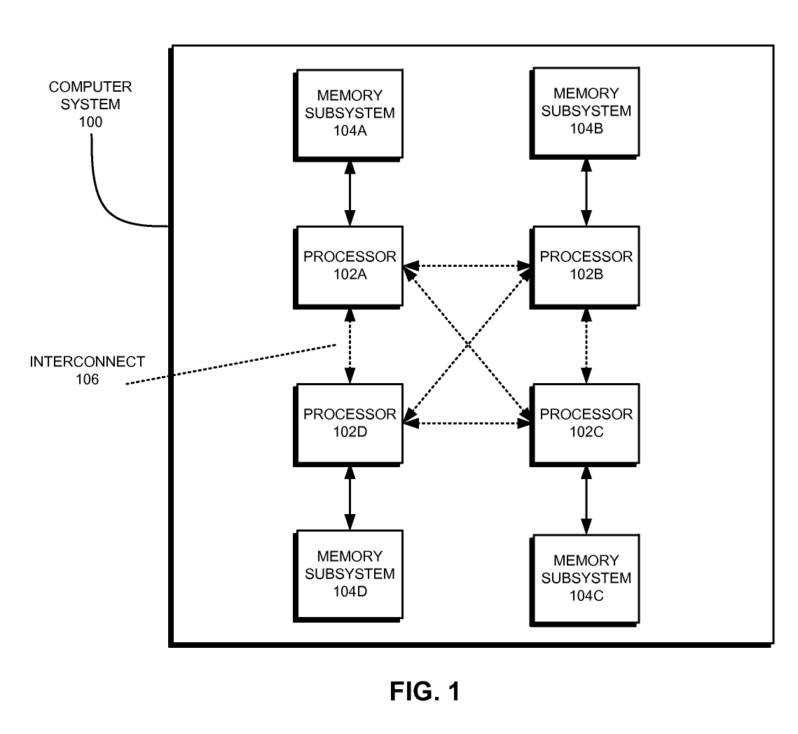

FIG. 1 presents a block diagram illustrating a computer system 100 in accordance with embodiments of the present invention. Computer system 100 includes processors 102A-102D, which each is coupled to memory subsystem 104A-104D. (Note that throughout this description, the term “memory subsystem” and “memory” may be used interchangeably. Also note that we generally refer to any of processors 102A-102D as a “processor 102”).

A processor 102A-102D may generally include any device configured to perform accesses to memory subsystems 104A-104D. For example, each processor 102A-102D may comprise one or more microprocessor cores and/or I/O subsystems. I/O subsystems may include devices such as a direct memory access (DMA) engine, an input-output bridge, a graphics device, a networking device, an application-specific integrated circuit (ASIC), or another type of device. Microprocessors and I/O subsystems are well known in the art and are not described in more detail.

Memory subsystems 104A-104D include memory for storing data and instructions for processors 102A-102D. For example, the memory subsystems 104A-104D can include dynamic random access memory (DRAM), synchronous dynamic random access memory (SDRAM), static random access memory (SRAM), flash memory, or another type of memory.

Processors 102A-102D can include one or more instructions and/or data caches which may be configured in a variety of arrangements. For example, the instruction and data caches can be set-associative or direct-mapped. Each of the processors 102A-102D within computer system 100 may access data in any of the memory subsystems 104A-104D, potentially caching the data. Moreover, coherency is maintained between processors 102A-102D and memory subsystems 104A-104D using a coherence protocol. For example, some embodiments use the MESI protocol. Alternative embodiments use a different protocol, such as the MSI protocol. Cache coherence protocols such as the MESI or MSI protocol are well known in the art and are not described in detail.

In some embodiments of the present invention, memory subsystems 104A-104D are configured as a distributed shared memory. In these embodiments, each physical address in the address space of computer system 100 is assigned to a particular memory subsystem 104A-104D, herein referred to as the “home” memory subsystem or the “home node” for the address. A home node can include a memory subsystem 104A-104D and the processor 102A-102D associated with that memory subsystem. For example, in some embodiments, the address space of computer system 100 may be allocated among memory subsystems 104A-104D in a cache line interleaved manner. In these embodiments, a given memory subsystem 104A-104D is not allocated blocks of contiguous cache lines. Rather, in a system which includes N memory subsystems, each memory subsystem may be allocated every Nth cache line of the address space. Alternative embodiments use other methods for allocating storage among memory subsystems, such as storing contiguous blocks of cache lines in each of the memory subsystems.

Although we describe a “home node” as being a node in a distributed shared memory system, in alternative embodiments, home nodes can be nodes within a computer system based on a different memory architecture. Generally, a home node is any type of computational resource associated with a cache line within a computer system. For example, a home node can be any memory location where a given memory controller keeps a record of the coherency status of the cache line. In some embodiments of the present invention, there is only one home node for all the cache lines in the system. For example, in embodiments of the present invention where the shared memory is one functional block (i.e., one integrated circuit chip), the home node can include the whole memory.

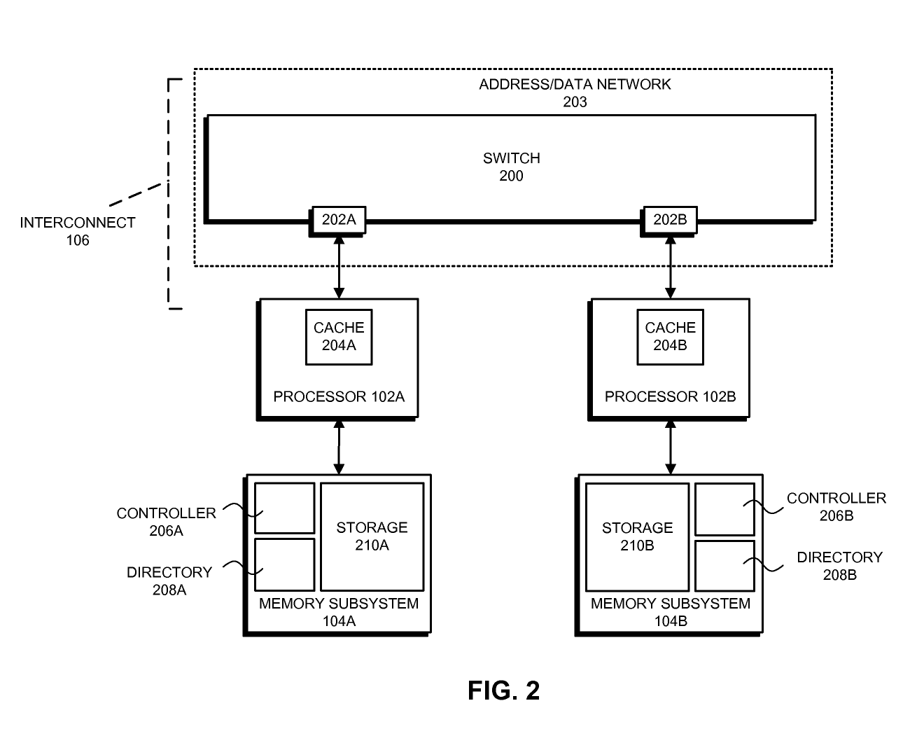

Each memory subsystem 104A-104D may also include a directory suitable for implementing a directory-based coherence protocol. In some embodiments, a memory controller in each node is configured to use the directory to track the states of cache lines assigned to the associated memory subsystem 104A-104D (i.e., for cache lines for which the node is the home node). Directories are described in detail with respect to FIG. 2.

Within computer system 100, processors 102A-102D are coupled via point-to-point interconnect 106 (interchangeably referred to as “interconnect 106”). Interconnect 106 may include any type of mechanism that can be used for conveying control and/or data messages. For example, interconnect 106 may comprise a switch mechanism that includes a number of ports (e.g., a crossbar-type mechanism), one or more serial or parallel buses, or other such mechanisms. Interconnect 106 may be implemented as an electrical bus, a circuit-switched network, or a packet-switched network.

In some embodiments, within interconnect 106, address packets are used for requests (interchangeably called “coherence requests”) for an access right or for requests to perform a read or write to a non-cacheable memory location. For example, one such coherence request is a request for a readable or writable copy of a cache line. Subsequent address packets may be sent to implement the access right and/or ownership changes needed to satisfy a given coherence request. Address packets sent by a processor 102A-102D may initiate a “coherence transaction” (interchangeably called a “transaction”). Typical coherence transactions involve the exchange of one or more address packets and/or data packets on interconnect 106 to implement data transfers, ownership transfers, and/or changes in access privileges. Packet types and transactions in embodiments of the present invention are described in more detail below.

FIG. 2 is a diagram illustrating in more detail a portion of computer system 100 in accordance with embodiments of the present invention. The portion of computer system 100 shown in FIG. 2 includes processors 102A-102B, memory subsystems 104A-104B (which are associated with processors 102A-102B, respectively), and address/data network 203.

Address/data network 203 is one embodiment of interconnect 106. In this embodiment, address/data network 203 includes a switch 200 including ports 202A-202B. In the embodiment shown, ports 202A-202B may include bi-directional links or multiple unidirectional links. Note that although address/data network 203 is presented in FIG. 2 for the purpose of illustration, in alternative embodiments, address/data network 203 does not include switch 200, but instead includes one or more busses or other type of interconnect.

As shown in FIG. 2, processors 102A-102B are coupled to switch 200 via ports 202A-202B. Processors 102A-102B each include a respective cache 204A-204B configured to store memory data. Memory subsystems 104A-104B are associated with and coupled to processors 102A-102B, respectively, and include controllers 206A-206B, directories 208A-208B, and storages 210A-210B. Storage 210A-210B can include random access memory (e.g., DRAM, SDRAM, etc.), flash memory, or any other suitable storage device.

Address/data network 203 facilitates communication between processors 102A-102B within computer system 100. For example, a processor 102A-102B may perform reads or writes to memory that cause transactions to be initiated on address/data network 203. More specifically, a processing unit within processor 102A may perform a read of cache line B that misses in cache 204A. In response to detecting the cache miss, processor 102A may send a read request for cache line A to switch 200 via port 202A. The read request initiates a read transaction. In this example, the home node for cache line B may be memory subsystem 104B. Switch 200 may be configured to identify processor 102B and/or memory subsystem 104B as a home node of cache line B and send a corresponding request to memory subsystem 104B via port 202B.

As is shown in FIG. 2, each of the memory subsystems 104A-104B includes a directory 208A-208B for implementing the directory-based coherence protocol. In this embodiment, directory 208A includes an entry for each cache line for which memory subsystem 104A is the home node. Each entry in directory 208A can indicate the coherency state of the corresponding cache line in processors 102A-102D in the computer system. Appropriate coherency actions may be performed by a particular memory subsystem 104A-104B (e.g., invalidating shared copies, requesting transfer of modified copies, etc.) according to the information maintained in a directory 208A-208B.

A controller 206A-206B within a memory subsystem 104A-104B is configured to perform actions for maintaining coherency within a computer system according to the specific coherence protocol in use in computer system 100. The controllers 206A-206B use the information in the directories 208A-208B to determine coherency actions to perform. (Note that although we describe controllers 206A-206B in memory subsystems 104A-104B performing the actions for maintaining coherency, we generically refer to the memory subsystem 104A-104B itself performing these operations. Specifically, within this description we sometimes refer to the “home node” for a cache line performing various actions.)

Computer system 100 can be incorporated into many different types of electronic devices. For example, computer system 100 can be part of a desktop computer, a laptop computer, a server, a media player, an appliance, a cellular phone, testing equipment, a network appliance, a calculator, a personal digital assistant (PDA), a hybrid device (e.g., a “smart phone”), a guidance system, audio-visual equipment, a toy, a control system (e.g., an automotive control system), manufacturing equipment, or another electronic device.

Although we describe computer system 100 as comprising specific components, in alternative embodiments different components can be present in computer system 100. Moreover, in alternative embodiments computer system 100 can include a different number of processors 102 and/or memory subsystems 104.

### Memory System

In embodiments of the present invention, computer system 100 supports virtual, real, and physical memory (interchangeably called virtual, real, and physical “memory spaces”). Applications operate in the virtual memory space, which means that the applications perform memory accesses using virtual memory addresses. Such accesses are indirect because virtual addresses are translated by processor 102 from virtual addresses to physical addresses. Translating a virtual address to a physical address involves first mapping the virtual address to a real address, and then mapping the real address to a physical address. Then, processor 102 uses the physical address to access physical memory locations in memory 104.

Generally, a physical memory address includes information that identifies a physical memory location, while a virtual memory address includes information that can be used to map (translate) the virtual address to a real address. The real memory space is another level of indirection in memory accesses that enables the system to provide an additional layer of abstraction when accessing memory 104, which can facilitate memory protection for virtual machines.

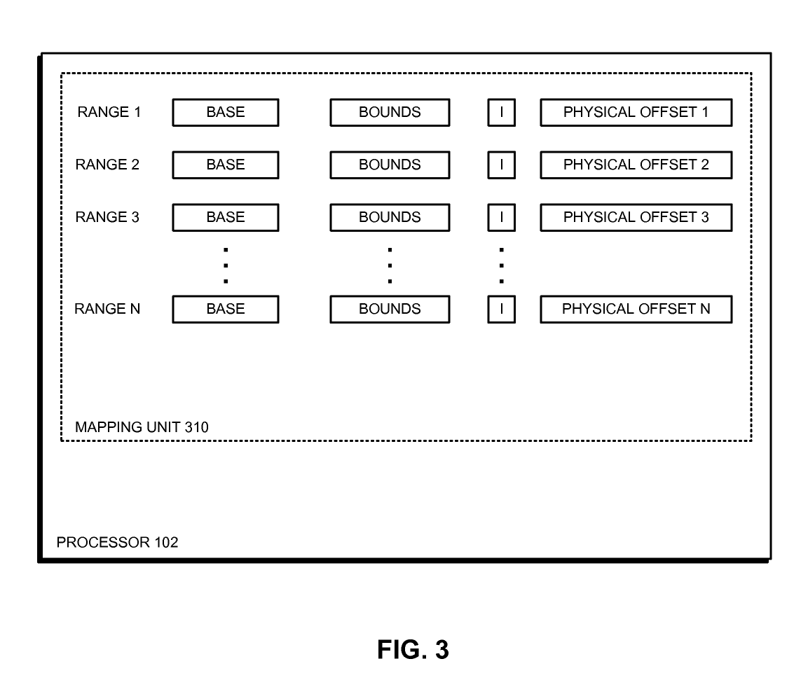

In order to enable the translation of virtual addresses to physical addresses, embodiments of the present invention include mechanisms for maintaining mapping information that facilitates performing the virtual-address-to-physical-address translation. For example, in some embodiments of the present invention processor 102 includes a real-address-to-physical-address mapping unit, which is described later with reference to FIG. 3.

Also, in some embodiments of the present invention, processor 102 includes a translation lookaside buffer (TLB) that maintains mapping information for virtual-address-to-real-address translations. In these embodiments, the TLB is a fast CPU cache that stores virtual-address-to-real-address mapping information in a local memory. Because TLBs are well-known in the art, they are not described in more detail.

Note that although we describe embodiments of the present invention that use a TLB, alternative embodiments use a different circuit structure, a data structure in a memory, or another mechanism to maintain mapping information. Also note that although we describe the TLB as including a cache for virtual-address-to-real-address translations, the TLB can also include one or more caches for other types of translations, such as virtual-address-to-physical-address translations, and real-address-to-physical-address translations. These alternative embodiments operate in a similar way to the described embodiments.

In embodiments of the present invention, the translation of real addresses to physical addresses is transparent to virtual machines. The translation is transparent because in these embodiments, processor 102 performs real-addresses-to-physical-addresses translations and maintains data structures for storing real-address-to-physical-address mapping information. Then, even given the additional layer of indirection that the real addresses facilitate, the circuits that generally perform virtual-address-to-physical-address mappings (e.g., TLB) can perform the virtual-address-to-real-address mappings without modification.

Processor 102 can provide memory isolation for virtual machines, which can involve mapping an exclusive region of memory 104 to a virtual machine. For example, in some embodiments of the present invention, processor 102 can assign and export to a virtual machine a set of real addresses for the virtual machine. Because the real addresses must be translated to physical addresses in order to access physical memory locations, processor 102 can isolate a virtual machine to a particular region of memory 104 by only mapping real addresses for that virtual machine to that region. Hence, processor 102 can prevent other virtual machines from accessing memory that is assigned to a specific virtual machine.

### Mapping Function

In the illustrated embodiments of the present invention, computer system 100 can support a single type of mapping from physical addresses to physical memory locations. For example, computer system 100 can map consecutive physical addresses to consecutive physical memory locations (i.e., a “contiguous,” or “non-interleaved” mapping). This single mapping simplifies routing and can simplify adding or removing processors with memory, and/or maintaining a reverse directory for cache coherence. However, in other embodiments of the present invention, computer system 100 can support other mappings of physical addresses to memory locations in addition to or instead of the contiguous mapping.

Performing a real-address-to-physical-address mapping can involve using a mapping function to determine the physical address to which the real address maps. The mapping function can map a set of real addresses to a set of physical addresses contiguously or interleavedly. Specifically, a mapping function that maps a set of real addresses contiguously can map consecutive real addresses to consecutive physical addresses. In addition, a mapping function that maps a set of real addresses interleavedly can map consecutive real addresses to interleaved physical addresses.

Processor 102 can include a mapping unit to perform the real-address-to-physical-address mappings. This mapping unit can receive a real address and can map the real address to a corresponding physical address. While mapping the real address to a physical address, the mapping unit can use attribute information to determine if the real-address-to-physical-address mapping is a contiguous mapping or an interleaved mapping. The mapping unit can include hardware to implement one or more mapping functions. Hence, the mapping unit can facilitate contiguous and interleaved access to memory 104 even though computer system 100 may only support a single type of mapping of physical addresses to physical memory locations.

In some embodiments of the present invention, a mapping function for a contiguous real-address-to-physical-address mapping performs this mapping by adding a fixed offset to the real address. In these embodiments, the mapping unit includes a fixed offset for each set of real addresses that the mapping unit can map to a corresponding set of physical addresses. And in some embodiments of the present invention, a mapping function for an interleaved real-address-to-physical-address mapping first performs a cyclic shift of one or more bits of the real address before adding a fixed offset. Interleaved mapping functions are described in more detail below.

A non-interleaved real-address-to-physical-address mapping can provide memory locality benefits. Specifically, in some embodiments of the present invention, N bits of a physical address (“home-node-select” bits) are used to determine the home node for the address. For example, the N most-significant bits of a physical address can be the home-node-select bits. Because traversing home nodes requires changing one or more of the home-node-select bits, a set of consecutive real addresses can be mapped to a single home node by adding to the real addresses a fixed offset which does not change the home-node-select bits.

In some embodiments of the present invention, a non-interleaved mapping of real addresses to physical addresses can reduce latency for some cache accesses because of locality. For example, in some embodiments of the present invention cache 204 is partitioned into banks, some of which are local to one or more processing cores in processor 102. In these embodiments, a physical memory address includes one or more “cache bank select” bits which can traverse banks of the multi bank cache, similar to how “home-node-select” bits can traverse home nodes. In some of these embodiments, a contiguous real-address-to-physical-address mapping which doesn't change the cache bank select bits can map a set of real addresses to a set of physical addresses that map to an L2 bank that is closer to one of the processing cores. Then, that core can access the cached copy of the page with lower latency than would be required to traverse a switch to get to the other L2 banks. Specifically, because consecutive physical addresses can be associated with consecutive cache lines, a contiguous real-address-to-physical-address mapping can map consecutive real addresses to the same cache, or the same bank of a multi-bank cache.

In some embodiments of the present invention, a mapping function for interleavedly mapping real addresses to physical addresses performs a cyclic shift of one or more bits of the real address. For example, some embodiments of the present invention use 64-byte cache lines and interleaving is performed at cache line granularity. In these embodiments, the cache line address can be obtained from any address within the cache line by deleting the 6 least significant bits of the address. Translating a real cache line address to a physical cache line address can involve cyclically shifting the real address 6 positions to the right, and then adding a fixed offset to the shifted address. Shifting the lower order bits of the real address to the home-node-select bits of the physical address can map consecutive real addresses to different, cyclically located home nodes. Note that the number of positions to shift can be determined from the interleaving granularity (in this example the real address is shifted 6 positions because the cache lines are interleaved 2⁶=64 ways).

An interleaved real-address-to-physical-address mapping can interleave cache accesses, because cyclically located physical addresses can be associated with cache lines in cyclically located cache banks. For example, rather than shift lower bits of a real address to home-node-select bits of a physical address, an interleaved mapping function can map lower order bits of the real address to “cache-bank-select” bits of a physical address. The cache-bank-select bits of a physical address determine the cache bank for the physical address. This type of interleaved mapping can facilitate retrieving consecutive cache lines in parallel, which can increase memory bandwidth. Specifically, an interleaved mapping can prevent “hot-spots” of traffic in a cache by distributing across home nodes accesses to consecutive addresses (or consecutive cache lines, as interleaving is often done at some granularity that is higher than a byte).

### Real-Address-to-Physical-Address Mapping Unit

FIG. 3 presents a block diagram illustrating a mapping unit 310 in accordance with embodiments of the present invention. Mapping unit 310 can map N sets of real addresses (“real ranges”) to physical addresses. For each real range, mapping unit 310 includes a base register, a bounds register, an attribute bit (I), and a physical offset register.

Mapping unit 310 is configured to map a real address to a physical address. Mapping unit 310 can store mapping information to facilitate mapping a set of real addresses to a set of physical addresses. The mapping information can include a mapping function for the set of addresses. In some embodiments of the present invention, the mapping information includes an attribute bit for each real range to indicate whether the real-address-to-physical-address mapping for the range is an interleaved or non-interleaved mapping.

In some embodiments of the present invention, mapping unit 310 maintains one or more predetermined mapping functions with the mapping information. In other embodiments of the present invention, mapping unit 310 can receive a mapping function for a desired interleaving, which mapping unit 310 can store with the mapping information.

In embodiments of the present invention, mapping unit 310 receives a real address and maps the real address to a corresponding physical address. Mapping unit 310 can perform the real-address-to-physical-address mapping by first comparing the received real address to the base and bounds registers for real ranges 1-N. Specifically, the base and bounds register for each range can include a base address and a bound for the range, respectively. Mapping unit 310 can determine the real range for a real address by determining a real range for which the real address is greater than (or equal to) the value of the base register, and smaller than (or equal to) the sum of the values of the base and bounds registers. In other words, mapping unit 310 can determine a real range RR corresponding to a real_address by determining the real range for which:

Base[RR]≦real_address≦Base[RR]+Bounds[RR]

where Base[RR] and Bounds[RR] are the values for the base and bounds registers for real range RR, respectively.

Mapping unit 310 can use attribute information to determine if a real address is to be mapped contiguously, or interleavedly. For example, mapping unit 310 can use an attribute bit I for the range corresponding to a real address to determine whether addresses in the range are mapped contiguously, or interleavedly. Note that other embodiments of the present invention can include two or more attribute bits for each real range. In these embodiments, different values for the attribute bits can correspond to different mapping functions. For example, attributes bits can indicate that a range is contiguous, or that the range is to be mapped using 8-way interleaving, 16-way interleaving, etc.

As described earlier, performing a contiguous real-address-to-physical-address mapping can involve adding to the real address a fixed offset. For example, mapping unit 310 can add to a real address the value of the physical offset register for the real range corresponding to the real address. In other words, when attribute bit I for a real range RR indicates that range RR is to be mapped contiguously, mapping unit 310 can calculate a physical address for the real address by adding to the real address the value of the physical offset register for range RR. Processor 102 can then use this physical address to access memory 104.

As was also described earlier, performing an interleaved real-address-to-physical-address mapping can involve performing a cyclic shift of some bits of a real address. For example, when attribute bit I for a real range RR indicates that range RR is to be mapped interleavedly, mapping unit 310 can determine a physical address for the real address by first performing a cyclic shift of one or more bits of the real address. Then, mapping unit 310 can calculate the physical address by adding to the shifted real address the value of the physical offset register for range RR. The number of positions to shift can be fixed, or it can be determined from the value of the attribute bits (when multiple attribute bits are used).

In some embodiments of the present invention, mapping unit 310 is configured to dynamically reconfigure the size and/or number of interleaved and non-interleaved ranges. For example, mapping unit 310 can dynamically reconfigure the size of an interleaved set of addresses for a virtual machine by removing real memory from a virtual machine and then adding back the real memory with a desired interleaving. In some embodiments of the present invention, mapping unit 310 can denote certain physical ranges to be interleaved and others to be non-interleaved so an operating system can map pages to real sets with the desired attributes.

Mapping unit 310 is configured to determine that a virtual memory page is to be reconfigured from an original real-address-to-physical-address mapping to a new real-address-to-physical-address mapping. For example, mapping unit 310 can receive a request to dynamically reconfigure a virtual memory page for a virtual machine, which can involve assigning and exporting to the virtual machine some real ranges that are mapped contiguously and/or some that are mapped interleavedly.

In some embodiments of the present invention, determining that a virtual page is to be reconfigured from an original to a new real-address-to-physical-address mapping can involve one or more operating conditions occurring. For example, in some embodiments of the present invention a set of physical addresses maps to memory locations that have lower latency than other memory locations (e.g., the home node for the set of addresses can be physically closer to the processor, or the memory can be local to the processor). In these embodiments, mapping unit 310 can determine that a contiguous real-address-to-physical-address mapping is more efficient for some virtual machines than an interleaved mapping, because the contiguous mapping can map the set of real addresses to the memory that is local to the processor. This type of contiguous mapping can reduce the latency of accessing memory when compared to the latency of retrieving data from non-local memory.

On the other hand, interleaved memory can improve memory throughput by distributing accesses to consecutive memory addresses across home nodes interleavedly. For example, with an interleaved mapping, shifting the lower order bits of a real address to the higher order positions of a physical address can map consecutive real addresses to different home nodes, which can improve throughput when accessing consecutive addresses.

Reconfiguring the virtual memory page from an original to a new real-address-to-physical-address mapping can involve converting a set of real addresses for the virtual memory page from being contiguously mapped to being interleavedly mapped, or vice versa. Converting the virtual memory page can involve determining a new mapping and/or mapping function for a set of real addresses for the virtual memory page. For example, mapping unit 310 can determine a new real-address-to-physical-address mapping for a set of virtual addresses in the virtual memory page by looking-up a range of real addresses for the virtual addresses that is arranged according to a desired new mapping.

Mapping unit 310 is configured to disable and enable accesses to a virtual memory page. Disabling access to a virtual memory page can prevent processor 102 from accessing to the virtual memory page while the virtual memory page is reconfigured from the original real-address-to-physical-address mapping to the new real-address-to-physical-address-mapping.

In some embodiments of the present invention, mapping unit 310 can disable accesses to the virtual memory page by initiating a “TLB shoot-down.” The TLB shoot-down, as is known in the art, is an operation that invalidates virtual-address-to-physical-address mappings in the TLB, and can involve loading in the TLB new virtual-address-to-physical-address mappings. In embodiments of the present invention that include a real memory space, the TLB shoot-down can invalidate the virtual-address-to-real-address mappings in the TLB. Mapping unit 310 can initiate a TLB shoot-down by sending an interrupt to processor, causing/throwing an exception, setting special register bits, or using memory-based semaphores. The TLB shoot-down is generally known in the art and is therefore not explained in further detail.

Note that in other embodiments of the present invention, mapping unit 310 uses different contiguous and/or interleaved mapping functions than those described above. Also, mapping unit 310 can use mechanisms other than base and bounds registers to determine a real range and/or mapping function for a real address.

Also note that a hypervisor can assign and export one or more real ranges to a virtual machine. In other words, a hypervisor can set-up the values of the base and bounds registers for each range. The hypervisor can also export one or more attribute bits to the virtual machine, which can facilitate the virtual machine selecting memory from both interleaved and non-interleaved real ranges.

### Method for Dynamically Reconfiguring Memory Interleaving

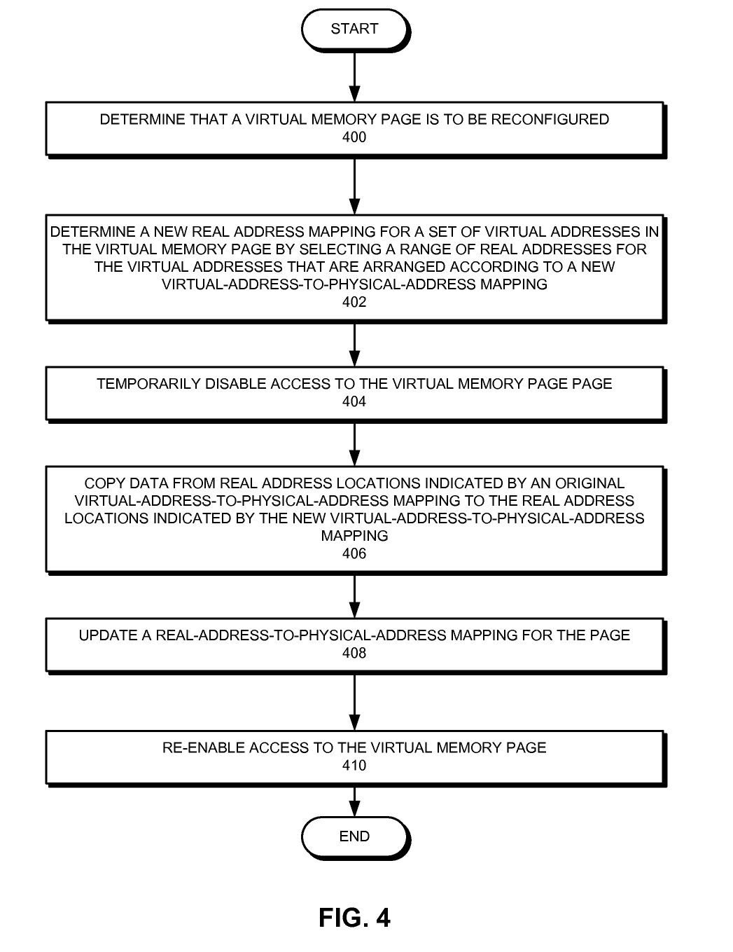

FIG. 4 presents a flowchart illustrating a process for dynamically reconfiguring memory interleaving in accordance with embodiments of the present invention.

The process for dynamically reconfiguring memory interleaving begins when mapping unit 310 determines that a virtual memory page is to be reconfigured from an original virtual-address-to-physical-address mapping to a new virtual-address-to-physical-address mapping (step 400). For example, mapping unit 310 can receive a request to reconfigure a virtual-address-to-physical-address mapping for a virtual memory page. Mapping unit 310 can select a real-address-to-physical-address mapping for the virtual memory page from one or more contiguous mappings, and one or more interleaved mappings.

Next, mapping unit 310 determines a new mapping function for a set of virtual addresses in the virtual memory page by selecting a range of real addresses for the virtual addresses that are arranged according to the desired new virtual-address-to-physical-address mapping (step 402). For example, mapping unit 310 can select a set of real addresses that are mapped according to the desired interleaving, and then assign the set of real addresses to the virtual memory page. In some embodiments of the present invention, mapping unit 310 determines a new mapping function by first determining that a contiguous real-address-to-physical-address mapping is more efficient for some virtual machines than an interleaved mapping.

Then, mapping unit 310 temporarily disables accesses to the virtual memory page (step 404). Next, processor 102 copies data from the real address locations indicated by the original virtual-address-to-physical-address mapping to the real address locations indicated by the new virtual-address-to-physical-address-mapping (step 406). Generally, an operating system can copy data and modify virtual-address-to-real-address mappings in a coherent manner so that it can stop accesses to the mapping while the copy is underway. Disabling accesses to the virtual memory page can simplify (or eliminate) the task of maintaining cache coherency while data is being copied.

Next, mapping unit 310 updates the real-address-to-physical-address mapping for the page (step 408). Updating the mapping can involve updating mapping information to associate a new mapping function with the set of real addresses. For example, mapping unit 310 can update mapping information to include a new interleaving function for a set of real addresses. Mapping unit 310 can determine the mapping function from existing mapping functions.

Then, mapping unit 310 re-enables accesses to the virtual memory page, which can involve re-instating a virtual-address-to-real-address mapping in the TLB and other structures (step 410). Enabling accesses to the memory page allows a virtual machine to access the virtual memory page with the new interleaving.

For illustrative purposes, the preceding discussion of embodiments of the present invention focuses on computer systems that include virtual, real, and physical memory spaces. However, because the intermediate step of translating virtual addresses to real addresses can be transparent to virtual machines, a person of skill in the art will recognize that embodiments of the present invention are readily applicable to other memory hierarchies, which can include more or fewer memory spaces.

### Performance Isolation for Threads

In some embodiments of the present invention, threads can share a cache memory. Sharing cache memory can improve performance when threads share data, but can also degrade performance when a highly active thread displaces cache lines for other threads (e.g., the highly active thread “thrashes” the cache). In these embodiments, mapping unit 310 can facilitate performance isolation for threads.

For example, a base-and-bounds mapping function can mask index-select-bits of a cache instead of home-node-select bits. Modifying index-select-bits can traverse indices in a cache. In these embodiments, a contiguous base-and-bounds mapping function can map consecutive real addresses for a thread to a subset of the indices within a cache. By moving lower order bits of a real address to the index-selection-bits of a physical address, embodiments of the present invention can guarantee a thread will only access a fraction of the cache. Threads can be given access to pages that map to different, non-overlapping sets of the shared cache, thus eliminating interference between the threads. Note that these sets can be assigned to maximize locality (as was done with the L2 cache banks above).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for dynamically reconfiguring memory interleaving, the method comprising:
determining that a virtual memory page is to be reconfigured from an original virtual-address-to-physical-address mapping to a new virtual-address-to-physical-address mapping;
determining a new real address mapping for a set of virtual addresses in the virtual memory page by selecting a range of real addresses for the virtual addresses that are arranged according to the new virtual-address-to-physical-address mapping;
temporarily disabling accesses to the virtual memory page;
copying data from real address locations indicated by the original virtual-address-to-physical-address mapping to real address locations indicated by the new virtual-address-to-physical-address mapping;
updating the real-address-to-physical-address mapping for the page; and
re-enabling accesses to the virtual memory page.

2. The method of claim 1, wherein a set of possible real-address-to-physical-address mappings for the virtual memory page includes a contiguous mapping and an interleaved mapping,
wherein in a contiguous mapping, the virtual addresses in the virtual memory page map to a corresponding range of real addresses, wherein the range of real addresses is mapped to a set of consecutively located physical addresses; and
wherein in the interleaved mapping, the virtual addresses map to a corresponding range of real addresses, wherein the range of real addresses is mapped to a set of cyclically located physical addresses.

3. The method of claim 2, wherein reconfiguring the virtual memory page involves converting the virtual page from being contiguously mapped to being interleavedly mapped or converting the virtual page from being interleavedly mapped to being contiguously mapped.

4. The method of claim 2, further comprising receiving one or more ranges of real addresses that are contiguously mapped or one or more ranges of real addresses that are interleavedly mapped.

5. The method of claim 2, wherein for the contiguous mapping, the consecutively located physical addresses are located in one bank of a multi-bank cache, and for the interleaved mapping, the cyclically located physical addresses are located in two or more banks of a multi-bank cache.

6. The method of claim 5, wherein for the contiguous mapping, the consecutively located physical addresses are located within a section of a cache bank, and for the interleaved mapping, the cyclically located physical addresses are located in two or more sections of a cache.

7. The method of claim 2, wherein determining that a virtual memory page is to be reconfigured involves determining that an operating condition has occurred that makes accessing cache lines within the cache more efficient using the new virtual-address-to-real-address mapping.

8. The method of claim 2, wherein temporarily disabling access to the virtual memory page involves performing a TLB shootdown, wherein performing the TLB shootdown involves at least one of:
generating an interrupt;
generating an exception;
setting special register bits; or
using memory-based semaphores.

9. An apparatus for dynamically reconfiguring memory, the apparatus comprising:
a processor;
memory coupled to the processor;
a mapping unit configured to:
determine that a virtual memory page is to be reconfigured from an original virtual-address-to-physical-address mapping to a new virtual-address-to-physical-address mapping
determine a new real address mapping for a set of virtual addresses in the virtual memory page by selecting a range of real addresses for the virtual addresses that are arranged according to the new virtual-address-to-physical-address mapping; and
update the real-address-to-physical-address-mapping for the page; and
temporarily disable and re-enable accesses to the virtual memory page;
wherein the processor is configured to copy data from real address locations indicated by the original virtual-address-to-physical-address mapping to real address locations indicated by the new virtual-address-to-physical-address mapping.

10. The apparatus of claim 9, wherein a set of possible virtual-address-to-physical-address mappings for the virtual memory page includes a contiguous mapping and an interleaved mapping,
wherein in a contiguous mapping, the virtual addresses in the virtual memory page map to a corresponding range of real addresses, wherein the range of real addresses is mapped to a set of consecutively located physical addresses; and
wherein in the interleaved mapping, the virtual addresses map to a corresponding range of real addresses, wherein the range of real addresses is mapped to a set of cyclically located physical addresses.

11. The apparatus of claim 10, wherein while reconfiguring the virtual memory page, the mapping unit is configured to convert the virtual page from being contiguously mapped to being interleavedly mapped or converting the virtual page from being interleavedly mapped to being contiguously mapped.

12. The apparatus of claim 10, wherein the mapping unit is further configured to receive one or more ranges of real addresses that are contiguously mapped or one or more ranges of real addresses that are interleavedly mapped.

13. The apparatus of claim 10, wherein for the contiguous mapping, the consecutively located physical addresses are located in one bank of a multi-bank cache, and for the interleaved mapping, the cyclically located physical addresses are located in two or more corresponding banks of a multi-bank cache.

14. The apparatus of claim 13, wherein for the contiguous mapping, the consecutively located physical addresses are located within a section of a cache bank, and for the interleaved mapping, the cyclically located physical addresses are located in two or more corresponding sections of multi-bank caches.

15. The apparatus of claim 10, wherein while determining that a virtual memory page is to be reconfigured, the mapping unit determines that an operating condition has occurred that makes accessing cache lines within the cache more efficient using the new virtual-address-to-real-address mapping

16. The apparatus of claim 10, wherein while temporarily disabling access to the virtual memory page, the control unit is configured to perform a TLB shootdown, wherein performing the TLB shootdown involves at least one of:
generating an interrupt;
generating an exception;
setting special register bits; or
using memory-based semaphores.

17. A computer-readable storage medium storing instructions that when executed by a computer cause the computer to perform a method for dynamically reconfiguring memory interleaving, the method comprising:
determining that a virtual memory page is to be reconfigured from an original virtual-address-to-physical-address mapping to a new virtual-address-to-physical-address mapping;
determining a new real address mapping for a set of virtual addresses in the virtual memory page by selecting a range of real addresses for the virtual addresses that are arranged according to the new virtual-address-to-physical-address mapping;
temporarily disabling accesses to the virtual memory page;
copying data from real address locations indicated by the original virtual-address-to-physical-address mapping to real address locations indicated by the new virtual-address-to-physical-address mapping;
updating the real-address-to-physical-address mapping for the page; and
re-enabling accesses to the virtual memory page.

18. The computer-readable storage medium of claim 17, wherein a set of possible virtual-address-to-physical-address mappings for the virtual memory page includes a contiguous mapping and an interleaved mapping,
wherein in a contiguous mapping, the virtual addresses in the virtual memory page map to a corresponding range of real addresses, wherein the range of real addresses is mapped to a set of consecutively located physical addresses; and
wherein in the interleaved mapping, the virtual addresses map to a corresponding range of real addresses, wherein the range of real addresses is mapped to a set of cyclically located physical addresses

19. The computer-readable storage medium of claim 18, wherein reconfiguring the virtual memory page involves converting the virtual page from being contiguously mapped to being interleavedly mapped or converting the virtual page from being interleavedly mapped to being contiguously mapped.

20. The computer-readable storage medium of claim 18, wherein the method further comprises: receiving one or more ranges of real addresses that are contiguously mapped or one or more ranges of real addresses that are interleavedly mapped.
